(19) United States
(12) Patent Application Publication
(10) Pub. No.: US 2003/0033400 A1
(43) Pub. Date: Feb. 13, 2003

(54) System and method for managing networks using local intelligent agents

(76) Inventors: Neal Pawar, Brooklyn, NY (US); Peter Reiss, New York, NY (US); David D. Rukshin, Edison, NJ (US)

Correspondence Address: KENYON & KENYON, 1500 K STREET, N.W., SUITE 700, WASHINGTON, DC, 20005, US

(21) Appl. No.: 10/193,998

(22) Filed: Jul. 15, 2002

Related U.S. Application Data
(60) Provisional application No. 60/304,797, filed on Jul. 13, 2001.

(51) Int. Cl. G06F 15/177; G06F 15/173

(52) U.S. Cl. 709/223; 709/220

(57) ABSTRACT

A method and system for network management. According to one embodiment, a centralized data store is used for central configuration of the monitoring and management of computers and their applications, an intelligent agent (running on each of the hosts of the managed network) has the capability to differentiate between the individuality of systems being managed by using rules based on attributes and variations in the attributes of the host system, and a graphical user interface is provided for centralized management of the hosts on the managed network. The invention may be used to carry out administrative tasks on the hosts of the managed network.

### CROSS REFERENCE TO RELATED APPLICATION

This application claims the benefit under 35 U.S.C. §119(e) of U.S. Provisional Application No. 60/304,797, filed Jul. 13, 2002, which is hereby incorporated by reference in its entirety.

### BACKGROUND OF THE INVENTION

One of the most common challenges faced by enterprise system administrators is managing and monitoring systems ranging from personal computers to servers across a network. Another challenge faced by system administrators is presented by applications running on these systems throughout the network—not only do they vary in terms of types, but also in terms of version number within the types. Moreover, applications are frequently changed by users which makes it difficult for systems administrators to manage, monitor and correct errors.

Currently, system administration is done by performing most actions manually, in which the system administrator (1) periodically issues commands to gather information regarding the state of the systems in the network, (2) detects any problems based on the above information, and (3) takes corrective actions for the detected problem. Automation of a system administrator's task is difficult for several reasons. One reason is that it is difficult to obtain data regarding the state of the systems. Typically, one must issue a variety of commands and consider several pieces of information from each command in order to diagnose a problem, and these commands must be repeated on each machine. Another reason is that the detection of a problem and creation of an appropriate solution depends on various external factors such as the occurrence time of the problem. For example, overloading of a system leading to a slow response is a problem during business hours but not at midnight. Identifying and testing of all conditions is a difficult task.

A common solution of the above network management problem is to utilize a tool that provides a centralized console that can be used to trap, monitor, and maintain a network environment. Another solution is to use a system of multiple consoles that monitors specific equipment individually. These solutions fail to solve the problems illustrated above.

Accordingly, there is a need in the art for a system and method that bridges these two approaches by providing a centrally configurable, distributed systems management platform.

### SUMMARY OF THE INVENTION

The present invention is directed to a network management system and method utilizing a centralized data store, an intelligent agent running on each of the hosts of the managed network, and a graphical user interface (“GUI”) for centralized management of the hosts on the managed network. The invention may be used to carry out administrative tasks on the hosts of the managed network.

Intelligent agents continuously run on every host in a network and perform a periodic attribute discovery procedure that collects a wide range of system information. The agents are centrally configured to evaluate rules made up of these attributes and to execute modules (programs) at specific times or intervals based on the evaluation. A method is disclosed by which the agent differentiates between hosts through the use of rules, and executes modules only on hosts for which such modules are appropriate. System administrators rely on this local intelligence of the agent to manage a heterogeneous network of computer systems (in the sense of varying operating system builds, features, installed software and versions of software).

Network administrators can change the configuration of a set of agents in real time using a graphical user interface, and the modified configuration is stored in a centralized data store. The data store serves as a secure repository of configuration information, modules, and logging information of the modules run on individual systems—which can later be queried for report generation. Agents poll the data store for configuration information in a manner that minimizes the network bandwidth utilization. Network administrators can also interact with any particular intelligent agent in real-time for monitoring and executing modules via a secure graphical user interface.

### BRIEF DESCRIPTION OF THE DRAWINGS

FIG. 1 is a block diagram that depicts a host in accordance with an embodiment of the present invention.

FIG. 2 is a block diagram that depicts a network architecture and process flow in accordance with an embodiment of the present invention.

### DETAILED DESCRIPTION

Host Architecture

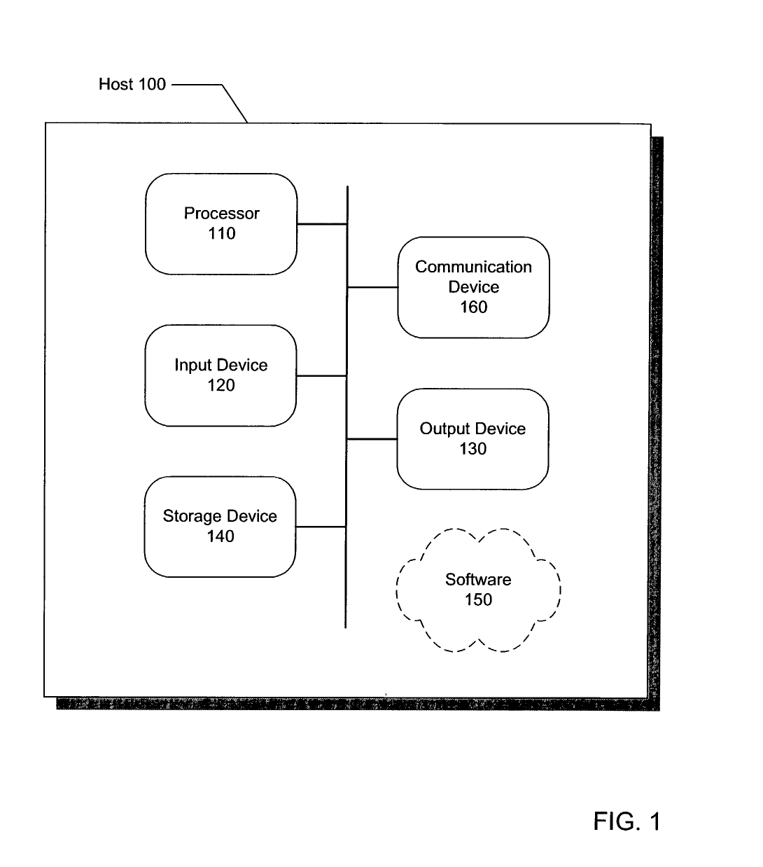

FIG. 1 is a block diagram depicting the internal structure of a host in accordance with an embodiment of the present invention. Host 100 may be a personal computer, handheld personal digital assistant (“PDA”), or any other type of processor-based device. Host 100 may include a processor 110, input device 120, output device 130, storage device 140, software 150, and communication device 160.

Input device 120 may include a keyboard, mouse, pen-operated touch screen, voice-recognition device, or any other device that provides input from a user. Output device 130 may include a monitor, printer, disk drive, speakers, or any other device that provides tangible output to user. Storage device 140 may include volatile and nonvolatile data storage. Volatile data storage includes RAM, a cache, or any storage medium that temporarily holds data while being processed; nonvolatile data storage includes a hard drive, CD-ROM drive, tape drive, removable storage disk, or any other non-temporary storage medium. Communication device 160 may include a modem, network interface card, or any other device capable of transmitting and receiving signals over a network.

Software 150 contains the logic used by the agent process of the present invention, as provided herein. Software 150 may take the form of custom-written programs and libraries that are either interpreted or compiled, and may be written in any programming language, such as C, C++, or JAVA.

One skilled in the art would appreciate that the components of host 100 may also be connected wirelessly, possibly through an infrared connection.

Network Data Flow

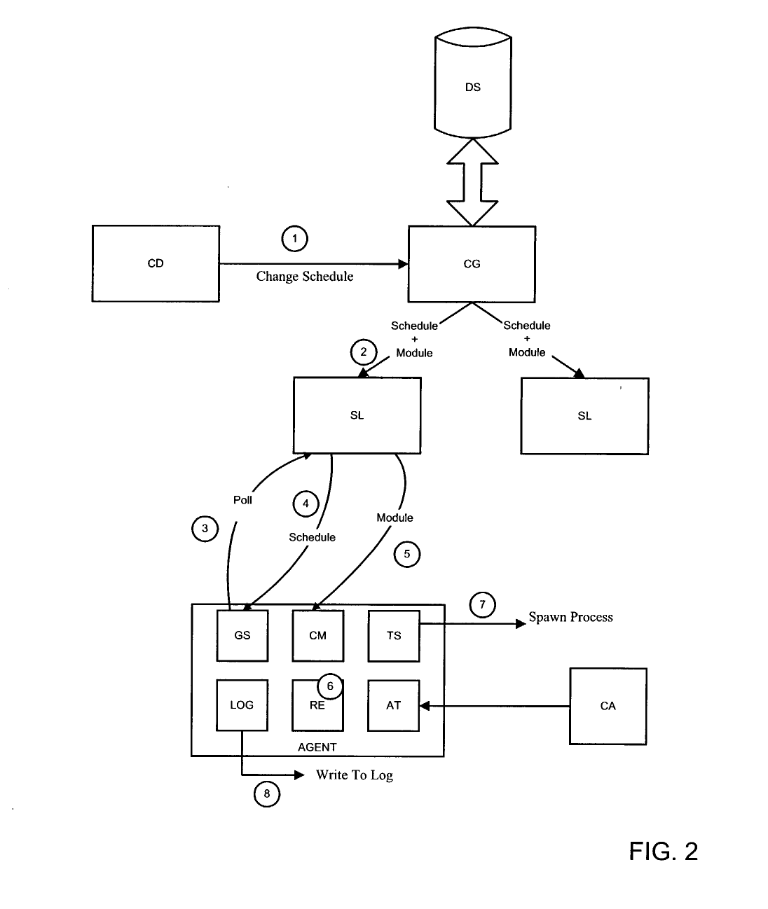

FIG. 2 is a block diagram depicting a network architecture and process flow in accordance with an embodiment of the present invention. According to one particular embodiment, when a network administrator schedules a module for execution on the managed hosts via graphical user interface CD (step 1), data store DS is updated via the master (server) CG. Master CG then pushes the new scheduling information to slaves (servers) SL (step 2). A list of slaves SL is stored in a configuration file on the master CG. Communications between master CG and slaves SL may be authenticated using certificates and end-to-end encryption using SSL.

Slaves SL store the scheduling information on a local cache. In an embodiment of the invention, the local cache is implemented on top of a file system and does not use a database. A state serial number is associated with scheduling information stored in the cache and this serial number is incremented each time slaves SL receive new scheduling information from master CG.

Agent AGENT (hereinafter just “Agent”) then polls slave SL to obtain the latest scheduling information (step 3). The polling interval and slave SL's server name is stored in a configuration file on Agent. Agent's getschedule component GS is used to fetch the scheduling information from slave SL (step 4). Agent stores the scheduling information locally in the file system (storage device 140), downloads the newly required modules from slave SL using copymanager component CM (step 5), and executes the modules based on the evaluation result of the rules associated with the targets (explained below). Ruleevaluator component RE performs the evaluation of the rules (step 6), and taskscheduler component TS spawns the processes to run the modules (step 7).

Components AT, GS, CM, RE and TS, in addition to various modules run by Agent, utilize component LOG to log information into an administrator configurable location (step 8). To avoid unnecessary downloads of scheduling information from slave SL, Agent first gets the state serial number in the cache of slave SL, compares it with the local serial number and then downloads the scheduling information from slave SL only if the serial number of slave SL is greater than the local serial number. All communications between slave SL and Agent may be authenticated using certificates and end-to-end encryption using SSL.

The network administrator can use graphical user interface CA to interact with Agent in real time. This enables the administrator to obtain real-time status information from the system (host 100) running Agent, and issue real time commands to Agent. Component AT handles all the requests made from user interface CA.

Agent can run in two modes: network connected and stand alone mode. When network connectivity to slave SL is present, Agent will operate in network-connected mode as described in the above paragraph. If no network connectivity to slave SL is detected, Agent will operate in stand-alone mode. In stand-alone mode operation, if scheduling information is present locally, Agent continues running as if connected to slave SL. If no scheduling information is present locally, Agent continues to poll for connectivity to slave SL. Should network connection become available at some later point, Agent starts operating in network-connected mode.

The present invention may utilize any network, network protocol and network connectivity as known in the art. Data store DS may comprise any storage-related medium and associated functionality, as commonly known in database management systems. Graphical user interface CD, user interface CA, master CG and slave SL comprise software employing their associated functionality as described herein, and the Agent's components comprise software 150. Master CG and slave SL may be implemented by any application server-computing device as known in the art, which includes elements similar to those of host 100. Specific computer software implementations are illustrated in the above-mentioned Provisional Application, incorporated by reference, for example at pages 30-42.

The following sections illustrate an embodiment of the present invention in which host 100 operates under a Microsoft Windows operating system provided by Microsoft Corp. of Redmond, Wash. It should be appreciated that actions and functionality attributed to Agent are attributable to all such agents in a managed network.

Attributes

Any property or true/false state of host 100 on which Agent is running can be defined as an attribute. For simplicity, the manager may give a symbolic name to each attribute for reference purposes while constructing rules and a value that can be Boolean, multi-valued or single-valued.

Agent performs attribute discovery on startup, at an interval defined by the administrator, or at any other time at administrator request. Some attributes are static properties of a system; others must be determined by querying the system or an external source. The attribute discovery process may be extensible using Windows Management Instrumentation (WMI) functionality, with which it is possible to define a method for discovering new attributes that Agent does not yet support.

TABLE 1 illustrates some attribute symbolic names and their description:

TABLE 1

| Attribute | | | |
|---|---|---|---|
| Name | Value Type | Possible values | Definition |
| ALL | Boolean | TRUE | Always TRUE |
| TRUE | Boolean | TRUE | Always TRUE |
| FALSE | Boolean | FALSE | Always FALSE |
| HOST | String | Any valid hostname | Short name (without DNS suffix) |
| HOSTNAME | String | Any valid DNS | Fully Qualified DNS name |
| | | hostname | |
| DEBUG_LEVEL | Integer | >=0 | Debug level under which Agent is running. |
| OS | String | Win2000, etc | Symbolic name for the operating system, one of |
| | | | predefined (in data store DS) types. |
| OSMAJOR | Integer | 4, 5 | The major number of the OS, 5 for Win2K, 4 |
| | | | for WinNT |
| OSMINOR | Integer | >=0 | Minor number of the version (for Win2K, minor |
| | | | number is 0) |
| OSMICRO | Integer | >=0 | Micro number of the version (Windows build |
| | | | number) |
| SP | Integer | >=0 | Service Pack number |
| DOMAIN | String | Cadessa.com | Name of Windows domain |
| DC | Boolean | TRUE/FALSE | True if system is a domain controller |
| SERVER | Boolean | TRUE/FALSE | True if host is a Windows Server |
| WORKSTATION | Boolean | TRUE/FALSE | True if host is a Windows Workstation |
| AD_DN | String | Any valid Active | Host's Active Directory Distinguished Name |
| | | Directory Distinguished | |
| | | Name | |
| AD_OU | String | Any valid | Last Organizational Unit in the AD_DN value |
| | | Organizational Unit | |
| | | Name | |
| AD_SITE | String | Any valid Active | Host's Active Directory Site Name |
| | | Directory Site | |
| LOG_TYPE | Integer | >=0 | Log type used by Agent (0 - STDOUT, 1- |
| | | | EventLog, 2 - File) |
| GROUP_XXX | Boolean | TRUE/FALSE | Defined on hosts that belong to Active |
| | | | Directory group XXX, where XXX is the name |
| | | | of the group. |

Modules

Modules are programs that are run by Agent. Any program can be a module. If it wishes to communicate with Agent, a module would include a means of communicating with Agent through the API provided by the agent. For example, the module could desire to get information on certain attributes, it may desire to make use of Agent's logging facilities or to report the Agent's status. There are no restrictions on what language the module needs to be written in. The module may be a batch file, a perl script, a VB (VisualBasic) program, or a compiled binary.

Targets

The administrator may wish to run the same module with different arguments on different schedules or on different hosts. A target is an arbitrary string name that is used to refer to an instance of a module. The target is also usually descriptive of the purpose of the use of the module. For example, a generic file installation program may be used to install different files on different schedules (e.g., BizApps and SQL.INI). The administrator would create a separate target for each task (since they are unrelated), and all scheduling and rules for running the module will be assigned to the target. In this example, the administrator would likely choose two target names, BizApps and SQL.INI, to make understanding configuration simpler.

There can be multiple instances of the same target name, so long as the rules and schedules applied to it are different. An example of this might be when an administrator wants to install BizApps on both a server and a workstation, but needs to supply different arguments to the module. Since the same function is being performed on both workstations and servers, the same target name should be used.

Rules

Like other agents with their respective hosts, Agent decides which modules to run based on a set of rules defined by the administrator. Rules are constructed by making Boolean expressions of attributes. If the expression evaluates to ‘TRUE’, then Agent will run particular modules associated with that rule; if the expression evaluates to ‘FALSE’, then this module does not run. This makes it possible to run a module with one set of arguments on a workstation and with another set on a server. All rules are applied to a target or a schedule, not to an individual module. If there is more than one rule applied to a target or schedule, the rules must be different (i.e. there should not be a union of machines where both rules would evaluate to TRUE).

If a rule expression does not evaluate to TRUE on a workstation, then the target is not valid on that machine. Thus, even if there is a valid schedule attached to the target for this particular workstation (the RULE for the schedule attached to the target evaluated to true), the target is not executed. This gives the administrator more fine grained control to separately adjust rules for defining targets and actually making them run.

An example of a rule specifying that a target should run on all systems except Domain Controllers would be:

!DC

A rule specifying that a target should run on hosts ‘foo’ and ‘bar’, and all hosts in AD (“Active Directory”) group ‘baz’, but not on Domain Controllers:

(HOST=foo∥HOST=bar∥GROUP_baz) &&!DC

Schedule

Agent may have the ability to schedule a target to be executed:

at a specific date/time;

at a specified interval;

at a randomly selected time within a specified window of time; and

when a specific event occurs; in particular, some events of interest are as follows:

on startup;

when a user logs in;

when a user logs out;

on Agent shutdown; and

any time at administrator request.

The administrator may attach multiple schedules to a single target. All schedules are controlled by rules, which determines which schedule(s) will apply to the target on the particular machine Agent is running on. If there is more than one schedule attached to a target, all of them must be honored.

Agent may only run a target if the rule for the target is true on the workstation (host 100) and if there is a schedule for the target with a ‘true’ rule.

Further embodiments of rules and schedules are illustrated in the above-mentioned Provisional Application, incorporated by reference, for example at pages 78-79.

Graphical User Interface

The administrator may use central graphical user interface CD to schedule the execution of modules on all of the managed hosts. The scheduling information is stored in data store DS via master CG. The GUI users may have to authenticate themselves to the data store DS before they can schedule tasks on the hosts.

The administrator can use graphical user interface CA to interact with Agent to obtain real-time status information. The administrator can query for individual host parameters such as:

running processes;

disk partition and usage information and drive mappings;

CPU utilization; top X processes, in particular;

memory usage (total, and by process);

system time; and

obtaining hardware details, such as BIOS version, CPU version.

The administrator may issue real-time commands to Agent, such as to:

determine which modules are currently running;

determine when a particular module will run next;

issue a request to run target/module now or at a particular time;

issue a request to terminate a currently running or pending (scheduled) module; and

suspend Agent operations for a specific period of time.

Data Store

Data store DS is a centralized location for storing the modules, scheduling information of Agent and logging information obtained from Agent. All communication to data store DS is through the API (Application Program Interface) provided by Master CG. Data store DS is implemented using a database.

Master CG/Slave SL

Master CG acts as a gateway between Agent or graphical user interface CD and the Data Store. Because there may be very limited bandwidth (e.g., WAN links) between Agent and master CG, a method to distribute configuration data is implemented by enabling master CG to be able to operate in two modes: as a master or a slave.

While running as a master (i.e., as master CG), it accesses information directly from data store DS. Master CG maintains a serial number to keep track of changes made to data store DS. Any time a change is made to data store DS by the administrator using graphical user interface CD, the serial number is incremented. Any time the serial number is incremented, master CG sends a notification to all slave servers (i.e., slaves SL). This notification contains the new serial number and modified data.

While running as a slave (i.e., as slave SL), it downloads all scheduling information and modules from master CG when it starts up. If there is a modification to the data in data store DS, it receives the modified data from master CG. Agent, running on a managed host, downloads the scheduling information and modules from slave SL.

Logging

Agent may log events of interest like start up, shut down, starting a module, stopping a module, errors etc. The administrator can define the level of logging on Agent, which determines the granularity of logging messages Agent and modules will do. This logging level is stored in a configuration file on Agent. For example, DEBUG_LEVEL may be an attribute defined by Agent, which specifies exactly how detailed logging should be. The higher the DEBUG_LEVEL, the more detailed logging should be done. Different possible logging levels supported by Agent may be debug, info, warning, error, critical, alert, and emergency.

The administrator can define the destination to which Agent and the modules should log. Agent may log to a local file system, a remote file system, data store DS, an event log and to the standard output console (stdout). The log destination may be stored in a configuration file on Agent.

Because log storage space is not infinite, Agent makes efficient use of space in that log messages are concise, yet useful. The administrator may configure the amount of logging space available to Agent. The maximum number of log files per agent and module and maximum size of each individual log file are stored in a configuration file on Agent. When the upper limit of number of log files is reached, the oldest log file is deleted to free space for new logs.

Different modules that run on host 100 may use the logging facility thorough an API provided by Agent. A separate log file is created for each target running on the host. This log file captures the start and end time of the execution of the module associated with the target, outputs by the module that are written to standard output console (stdout) and error messages that are produced by the module to standard error console (stderr).

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method for managing a network, comprising:
receiving from a user host-management configuration data for a host machine on a network, the configuration data including a rule defined by the user and identification of a module to be executed on the host machine based on the user-defined rule; and
sending the configuration data to the host machine, the host machine running an agent process to decide whether to cause the module to be executed based upon evaluation of the rule by the agent process.

2. The method of claim 1, further comprising storing the configuration data in a data store.

3. The method of claim 1, wherein the configuration data is sent to the host machine via an intermediary server.

4. The method of claim 1, wherein the rule includes a Boolean expression of at least one attribute of the host machine.

5. The method of claim 4, wherein the at least one attribute includes at least one of operating system build number, host name, whether the host is a workstation and server or domain controller.

6. The method of claim 1, wherein the rule includes a temporal expression.

7. The method of claim 6, wherein the rule specifies at least one of a particular time and particular time interval.

8. The method of claim 7, wherein the particular time includes at least one of startup, shutdown, logon and logoff.

9. The method of claim 1, wherein the host machine conducts periodic attribute discovery to collect information about at least one attribute of the host machine.

10. The method of claim 9, wherein the collected information includes at least one of operating system, network adapter configuration and hardware identification.

11. The method of claim 10, wherein the host-management configuration data is configured using a graphical user interface.

12. The method of claim 1, further comprising sending the configuration data to a second host machine on the network, the second host machine running an agent process to decide whether to cause the module to be executed based upon evaluation of the rule by the agent process.

13. The method of claim 12, wherein the agent process running on the second host machine operates independently of an agent process running on any other host machine.

14. A system for managing a network, comprising:
a master server machine configured to receive from a user host-management configuration data for a host machine on a network, the configuration data including a rule defined by the user and identification of a module to be executed on the host machine based on the user-defined rule; and
a host machine that receives configuration data, the host machine configured to run an agent process to decide whether to cause the module to be executed based upon evaluation of the rule by the-agent process.

15. The system of claim 14, further comprising:
a slave server machine configured to receive the configuration data from the master server machine and to send the configuration data to the host machine upon receiving a polling request by the host machine.

16. The system of claim 14, further comprising:
a second host machine that receives configuration data, the second host machine configured to run an agent process to decide whether to cause the module to be executed based upon evaluation of the rule by the agent process.

17. The system of claim 16, wherein the agent process running on the second host machine operates independently of an agent process running on any other host machine.

18. A system for managing a network, comprising:
a processor; and
a memory, coupled to the processor, storing instructions adapted to be executed by the processor to:
receive from a user host-management configuration data for a host machine on a network, the configuration data including a rule defined by the user and identification of a module to be executed on the host machine based on the user-defined rule;
send the configuration data to the host machine, the host machine running an agent process to decide whether to cause the module to be executed based upon evaluation of the rule by the agent process.

19. The system of claim 18, wherein the instructions are further adapted to store the configuration data in a data store.

20. The system of claim 18, wherein the configuration data is sent to the host machine via an intermediary server.

21. The system of claim 18, wherein the rule includes a Boolean expression of at least one attribute of the host machine.

22. The system of claim 21, wherein the at least one attribute includes at least one of operating system build number, host name, whether the host is a workstation and server or domain controller.

23. The system of claim 18, wherein the rule includes a temporal expression.

24. The system of claim 23, wherein the rule specifies at least one of a particular time and particular time interval.

25. The system of claim 24, wherein the particular time includes at least one of startup, shutdown, logon and logoff.

26. The system of claim 18, wherein the host machine conducts periodic attribute discovery to collect information about at least one attribute of the host machine.

27. The system of claim 26, wherein the collected information includes at least one of operating system, network adapter configuration and hardware identification.

28. The system of claim 27, wherein the host-management configuration data is configured using a graphical user interface.

29. The system of claim 18, wherein the instructions are further adapted to send the configuration data to a second host machine on the network, the second host machine running an agent process to decide whether to cause the module to be executed based upon evaluation of the rule by the agent process.

30. The system of claim 29, wherein the agent process running on the second host machine operates independently of an agent process running on any other host machine.

31. A system for managing a network, comprising:
means for receiving from a user host-management configuration data for a host machine on a network; and
means for sending the configuration data to the host machine, the host machine running an agent process to decide whether to process the configuration data.

32. A host machine operating in a managed network, comprising:
a processor; and
a memory, coupled to the processor, storing instructions adapted to be executed by the processor to:
receive host-management configuration data, the configuration data including a rule defined by a user and identification of a module to be executed on the host machine based on the user-defined rule; and
decide whether to cause the module to be executed based upon evaluation of the rule.

33. A machine readable medium having stored thereon instructions adapted to be executed by a processor, said instructions comprising instructions to:
receive host-management configuration data, the configuration data including a rule defined by a user and identification of a module to be executed on the host machine based on the user-defined rule; and
decide whether to cause the module to be executed based upon evaluation of the rule.

34. The machine readable medium of claim 33, further comprising instructions to:
download a module from a central repository; and
execute the downloaded module.

35. The machine readable medium of claim 33, further comprising instructions to:
schedule execution of a module based upon at least one of a specific date/time, a specific interval, a randomly selected time within a specified window of time, and upon occurrence of a specific event.
